(19) United States
(12) Patent Application Publication
(10) Pub. No.: US 2007/0286308 A1
(43) Pub. Date: Dec. 13, 2007

(54) System and method for modulated signal generation method using two equal, constant-amplitude, adjustable-phase carrier waves

(76) Inventor: Thomas Holtzman Williams, Longmont, CO (US)

Correspondence Address: THOMAS H. WILLIAMS, 6423 FAIRWAYS DR, LONGMONT, CO, 80503, US

(21) Appl. No.: 11/451,122

(22) Filed: Jun. 12, 2006

(51) Int. Cl. H04L 27/12

(52) U.S. Cl. 375/302

(57) ABSTRACT

This invention describes a system and a method to generate a modulated signal of an arbitrary angle and magnitude using two equal constant-amplitude carrier waves, each with adjustable-phase angles. The modulated signal is vector sum is created by combining the first carrier wave with the second carrier wave, where the phase angles of the first and second carrier waves determines both the magnitude and the phase of the desired modulated signal The necessary phase angle adjustment of the first and the second carrier waves can be achieved by rapidly reprogramming numerically controlled oscillators (NCOs), which are also known as direct digital synthesis (DDS) signal generators. This technique eliminates the inefficiency of conventional linear amplifiers and allows a single transmitter to efficiently generate signals with multiple modulation types. This technique also eliminates conventional modulators, which convert baseband signals into radio frequency signals. The generated signal may be transmitted, or utilized locally in test equipment, or for driving devices such as lasers, or for recording.

### BACKGROUND

1. Field of the Invention

This application is related to methods for generating high-power modulated radio frequency signals.

2. Description of Prior Art

RF (radio frequency) signals utilize many types of modulation for information transmissions over both wired and wireless signal paths. Modulation types may be for analog or for digital signal transmission. Common modulation types are amplitude modulation (AM), frequency modulation (FM), and phase modulation (PM). AM varies the amplitude of a carrier wave to send information, while PM changes the phase of a carrier wave to send information. A carrier wave is a high-frequency cosine (or sine) wave capable of passing through a medium, such as atmosphere, outer space, or a cable. FM changes the frequency of a carrier wave to send information, and may be viewed as a relative of PM. Digital modulation techniques, such as n-QAM (quadrature amplitude modulation) or n-VSB (vestigial sideband) transmit data by modulating a carrier wave with predefined amplitudes and phases. “n” defines the number of symbol states that are allowed for a given modulation type. Modulated high-power signals that have constant amplitude (such as FM) are more efficient to generate than signals that change amplitude (such as AM). This is because signals that have constant amplitude can use a saturated amplifier, but signals that change amplitude must use a linear amplifier. Linear amplifiers are inefficient and consume much more power than they transmit. Furthermore, a transmit level must be reduced from a maximum possible level to reduce non-linear distortion. Other signal types that change both amplitude and phase are spread spectrum signals and orthogonal frequency division multiplex (OFDM) signals.

This invention discloses a method to efficiently generate signals that change amplitude and/or phase without using a linear amplifier. In addition, the invention allows a single transmitter to generate high-powered signals with a plurality of different modulation types.

### SUMMARY OF THE INVENTION

A desired modulated signal, with an independently adjustable magnitude and an independently adjustable phase, is transmitted as a vector sum of two equal amplitude carriers with constant amplitudes. The phase angles of the two equal amplitude carriers are adjusted to produce the desired signal. The phase of the first carrier and the phase of the second carrier are offset from the phase of the desired carrier by equal and opposite angles. The desired signal is a vector sum of the first carrier and the second carrier.

### DESCRIPTION OF THE DRAWINGS

FIG. 1 is a prior art block diagram of a transmitter employing a linear amplifier.

FIG. 2 is vector diagram illustrating two vectors that are summed to make any arbitrary signal.

FIG. 3 is a vector diagram illustrating two vectors that are summed to make an AM modulated signal.

FIG. 4 is a vector diagram illustrating two vectors that are summed to make a FM or PM modulated signal.

FIG. 5 is a prior art block diagram of a numerically controlled oscillator.

FIG. 6 is a block diagram of a system to generate two equal constant-amplitude, varying-phase carriers.

FIG. 7 is a flow diagram of the process to compute the angles of the two carrier waves.

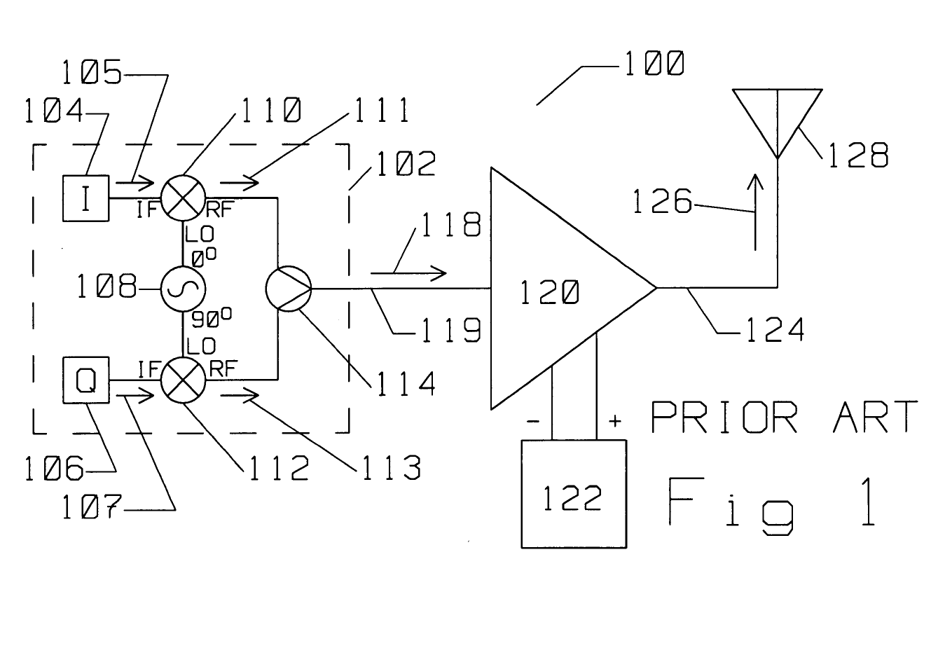

### DESCRIPTION FIG. 1

FIG. 1 is a block diagram 100 that shows prior art. A signal source 102 generates a low power radio frequency (RF) modulated signal 118 to be transmitted. The RF modulated signal 118 can have varying amplitude, varying phase, or varying amplitude and phase. The low power RF modulated signal 118 may, for example, be a 16-QAM modulated carrier. An in-phase (I) baseband signal source 104 creates a baseband I signal 105, which is connected to an intermediate frequency (IF) port of a first mixer 110. A local oscillator (LO) port of the first mixer 110 is connected to a 0 degree terminal of a local oscillator 108. The first mixer 110 upconverts the I baseband signal 105 to an I modulated signal 111. A quadrature (Q) baseband signal source 106 generates a baseband Q signal 107 which connects to an IF port of a second mixer 112. The second mixer 112 upconverts the baseband Q signal 107 to a Q modulated signal 113. A LO port of the second mixer 112 is connected to the 90 degree port of the local oscillator 108. A low power combiner 114 combines I modulated signal 111 and Q modulated signal 113 to make the low power modulated RF signal 118.

The RF modulated signal 118 is a vector addition of the I modulated signal 111 and the Q modulated signal 113. A line 119 passes the modulated RF signal 118 into a linear amplifier 120, which is fed power by a power supply 122, shown with positive and negative terminals. The linear amplifier 120 boosts the RF modulated signal 118 and outputs a high power RF modulated signal 126, which connects to an antenna feed line 124 that is connected to an antenna 128. The antenna 128 radiates the high power RF modulated signal 126.

The signal 118, which is a vector sum of the I modulated 111 signal and the Q modulated signal 113, can also be represented at any point in time as a magnitude (or amplitude) and a phase angle. Sometimes I signals are referred to as real signals and Q signals are referred to as imaginary signals. The elements inside signal source 102 form a complex modulator, which is well known in the art.

The disadvantage of this system is that the linear amplifier 120 draws much more power from the power supply 122 than it transmits to the antenna 128. If the linear amplifier is overdriven, it generates undesirable non-linear distortion. Sometimes a linearizer circuit, not illustrated, is inserted into line 119 to improve efficiency. The linearizer circuit cancels the non-linear distortion that the linear amplifier 120 creates, allowing more non-distorted power output to go to the antenna 128, thereby improving efficiency.

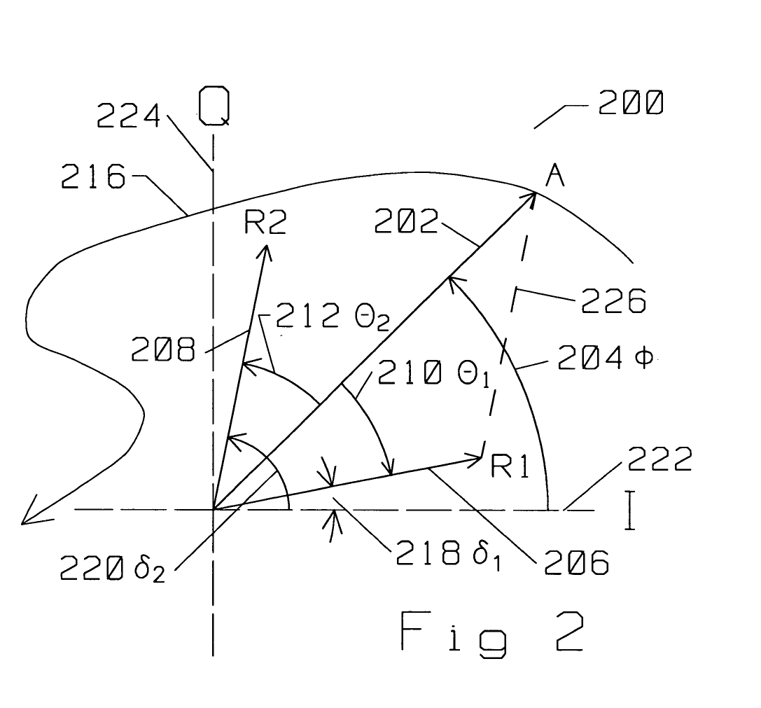

### DESCRIPTION FIG. 2

FIG. 2 shows a vector diagram 200 of summed vectors. The vectors are plotted on a Cartesian coordinate system with an in-phase (I) axis 222 and a quadrature (Q) axis 224. Vector plots of real and imaginary signals are well known in the art. A desired signal 202 has a magnitude of “A” and a desired signal angle 204 φ. A magnitude (or amplitude) “A” is the length of the desired signal 202 vector. A vector addition of two signals, a first carrier 206 and a second carrier 208, form the desired signal 202. A vector addition can be done by separately summing the real parts and the imaginary parts of the component vectors. The carriers 206 and 208 have equal and constant amplitudes of R1 and R2 respectively. The first carrier 206 is set at a first relative carrier angle 210 θ₁ relative to the desired signal angle 204 φ, and the second carrier 208 is set at a second carrier angle 212 θ₂ relative to the desired signal angle 204 φ. θ₁ and θ₂ are essentially equal angles. An absolute first carrier angle 218 δ₁ is:

δ₁=φ−θ₁ (1)

and an absolute second carrier angle 220 δ₂ is:

δ₂=φ+θ₂ (2)

The desired signal 202 may dynamically change both its magnitude A and its phase φ with time, as shown by a possible signal trajectory 216. The desired signal 202 is the vector sum of the first carrier 206 and the second carrier 208, which both dynamically change phase but hold constant and equal amplitudes. Any point on the vector diagram 200 can be reached by a vector sum of the first carrier 206 and the second carrier 208, provided that its distance from the origin (0,0) is less than or equal to twice the amplitude of R1 or R2. This technique can be used to generate any type of modulated signal. To illustrate vector addition, dotted line 226 show how a vector of the second carrier 208 is added to a vector of the first carrier 206 to create the vector sum, desired signal 202.

The vector sum of 2 carriers method illustrated in FIG. 2 is more power efficient than the linear amplifier method of FIG. 1 because it is more efficient to generate a single powerful signal using a vector sum of 2 high-powered carriers than to use the linear amplifier. Improved power efficiency translates to lower electric bills on high-powered transmitters and improved battery life on the portable low-powered transmitters. The generated desired signal 202 can be transmitted as desired, or used for other purposes. Other application include, but are not limited to, driving a laser, recording, driving a solenoid, transducer, audio speaker, or other load, or in test equipment.

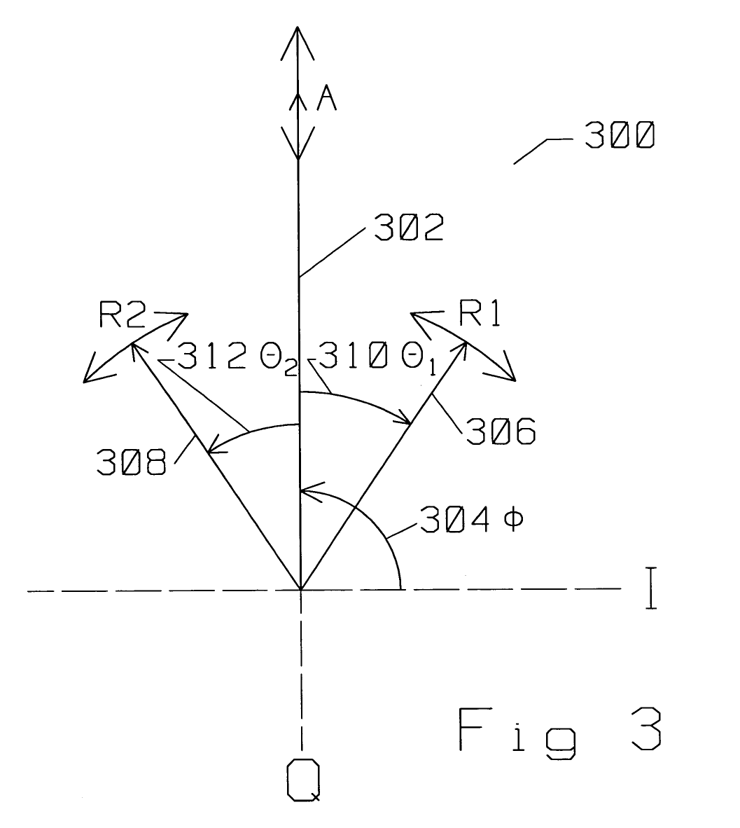

### DESCRIPTION FIG. 3

FIG. 3 is a vector diagram 300 of an amplitude-modulated (AM) desired signal 302 that is comprised of a first carrier 306 and a second carrier 308. A desired signal angle 304 φ remains fixed at +90 degrees, while a first carrier angle 310 θ₁ and a second carrier angle 312 θ₂ traverse between 0 and 90 degrees, but are always equal and in opposite directions. As the first carrier angle 310 θ₁ and the second carrier angle 312 θ₂ are reduced, their vector sum of the amplitude modulated desired signal 302 increases. Vector motion is illustrated by the larger arrows in the diagram 300. As the first carrier angle 310 θ₁ and the second carrier angle 312 θ₂ are increased, their vector sum, desired signal 302 decreases. Thus, the amplitude-modulated signal can have any amplitude between 0 and R1+R2.

This signal generation method could be used as an energy-efficient replacement for conventional AM radio transmitters that have used linear amplifiers for many decades.

Alternately, if the first carrier wave angle 310 and second carrier wave angle 312 are allowed to go between 0 and 180 degrees, the amplitude-modulated desired signal 302 can go negative with signal angle 340 at −90 degrees. This system can be used for amplitude shift keyed (ASK) digital transmissions or for binary phase shift keyed (BPSK) digital transmissions.

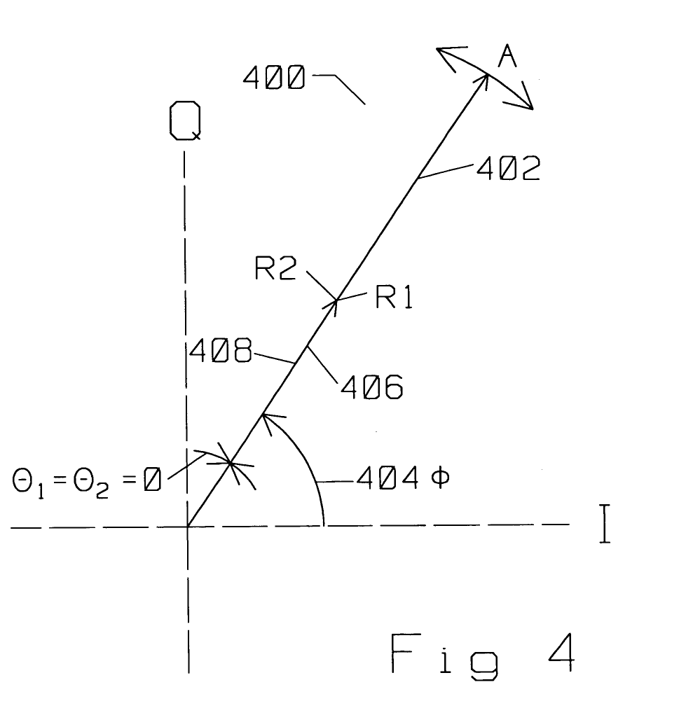

### DESCRIPTION FIG. 4

FIG. 4 is a vector diagram 400 of a FM or PM desired signal 402 that can be generated from a first carrier 406 and a second carrier 408 that have the same dynamically-varying phase angle. That is, they lie on top of each other. A first carrier angle θ₁ and a second carrier angle θ₂ remain at 0 degrees, but a desired signal angle 404 φ varies dynamically with time. Thus the magnitude of the PM or FM signal is R1 plus R2 and the phase may rotate to any value.

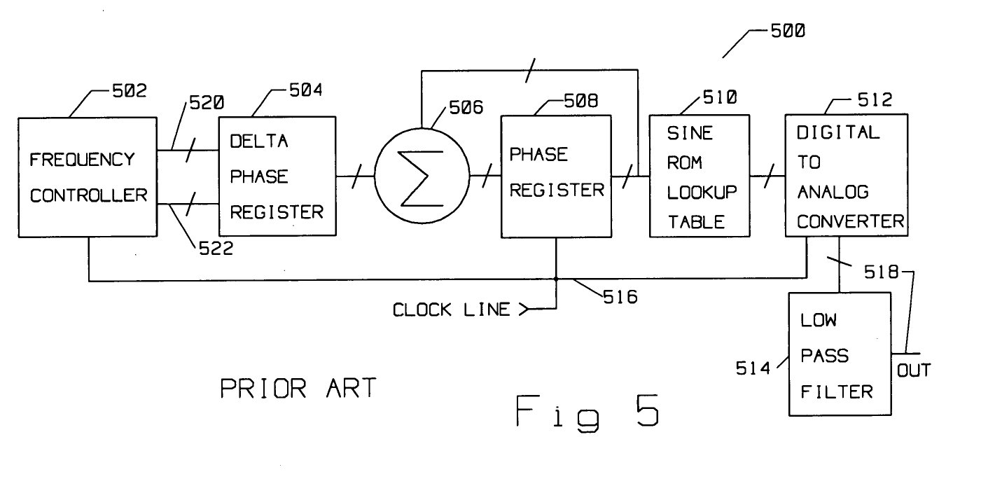

### DESCRIPTION FIG. 5

FIG. 5 shows a block diagram of a NCO 500. NCOs are well known in the art and are sold in integrated circuit form by multiple vendors They generate precision sine waves with adjustable phases by incrementing digital counters with adjustable accumulators. NCOs have characteristics of tight phase control and high frequency stability. A description of the theory of operation of NCOs is given in High Speed Design Techniques published by Analog Devices in Section 6 (1996, ISBN-0-916550-17-6). An Analog Devices part number AD9851BRS NCO may be used in this application. A frequency controller 502 programs the NCO to step in frequency or phase. The frequency controller 502 provides a data lines bus 520 and a control lines bus 522 to control and re-program a delta phase register 504. A NCO is a digital circuit that comprises the delta phase register 504, an adder or a summer 506, a phase register 508, a sine read-only memory (ROM) lookup table 510, and a digital-to-analog converter (D-A) 512. A low-pass filter 514 removes aliased components. A clock line 516, operating at a relatively high clock frequency, is applied to the phase register 508, the frequency controller 502, and the D-A 512.

The NCO operates by adding the output of the phase register 508 to the value stored in the delta phase register 504 on each clock cycle, and then storing a sum back into the phase register 508. In other words, the sum is accumulated in the phase register 508. The value stored in the delta phase register 504 is proportional to the frequency being generated. The change in phase generates the output frequency of the NCO. Thus, the output of the phase register is a digital word representing the instantaneous phase of the signal. The digital phase value is converted into a digital sine wave by the ROM lookup table 510. This digital sine wave is converted into analog form by the D-A converter 512, whose output is filtered by the low-pass filter 514. An output lead 518 provides the analog output signal.

If the delta phase register 504 has a large value, then the phase register 508 increments in large steps on each clock cycle, which causes the generation of a high-frequency signal. If the delta phase register 504 has a small value, then the phase register 508 increments in small steps on each clock cycle, which causes the generation of a low frequency signal. The desired signal angle 204 φ is set by adjusting the delta phase register 504 through frequency controller 502.

A step adjustment in phase is accomplished by incrementing the value of the delta phase register 504 upward or downward, allowing the accumulator to accumulate for one or more clock cycles, and then returning the value of the delta phase register 504 back to its original value. The value of the delta phase register 504 determines how much phase angle is added on each accumulate cycle.

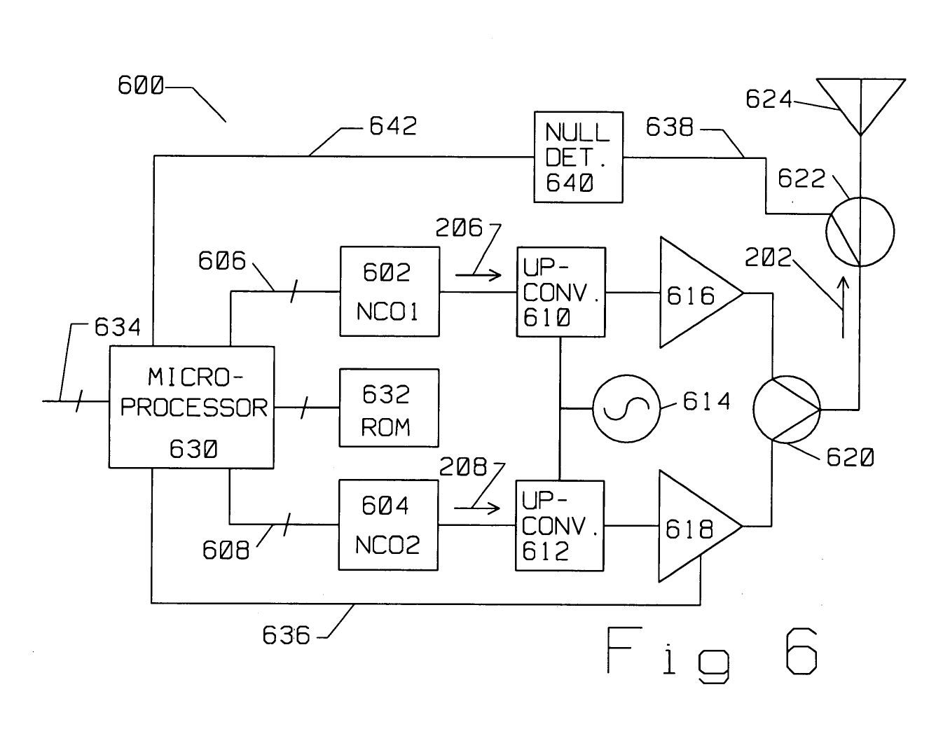

### DESCRIPTION FIG. 6

FIG. 6 is a block diagram 600 of a system that can be used to generate the desired signal 202. A first NCO 602 generates the first carrier 206 and a second NCO 504 generates the second carrier 208. Both the first and the second NCOs contain low pass filters, thereby producing analog carrier waves of fixed amplitude and adjustable phase. The first carrier 206 and the second carrier 208 are mixed to radio frequencies (RF) by upconverters 610 and 612 for transmission. A common local oscillator 614 is used by both upconverters to insure that, if there is any phase noise on the upconverted carriers, it is identical. An amplifier 616 amplifies the first carrier 206 and a second amplifier 618 amplifies the second carrier 208. Amplifiers 616 and 618 produce equal fixed-amplitude carriers. Both amplifiers can be efficient saturated amplifiers, not inefficient linear amplifiers. High power combiner 620 combines both the first carrier 206 and the second carriers 208 to make the desired signal 202. The desired signal 202 is sampled in a directional coupler 622 before being passed to an antenna 624.

A microprocessor 630 is used to control the programming of both NCO 602 and NCO 604. The microprocessor 630 receives the magnitude and phase information on the desired signal 202 via line 634. The information could be in the form of I and Q values, or in the form of magnitude and angle values. The microprocessor may compute the relative angles θ₁ and θ₂ of the first and second carrier from the desired signal's magnitude A and R1 (which equals R2):

$${θ}_{1} = {θ}_{2} = {cos}^{- 1} \frac{A}{2 \cdot R 1} \qquad ( 3 )$$

θ₁ is subtracted from the desired signal angle 204 φ to give the absolute first carrier angle 218 δ₁, and θ₂ is added to the desired signal angle 204 φ to give the absolute second carrier angle 220 δ₂, as shown in equations (1) and (2) above. The frequency controller 502 is programmed to generate the absolute first carrier angle 218 δ₁ on NCO1 602 and generate an absolute second carrier angle 220 δ₂ on NCO2.

Because the NCOs need to be updated rapidly for wide bandwidth applications, it is faster to use a look-up table to find the inverse cosine values than to calculate an inverse cosine from an algorithm. The look-up table may be contained in a ROM 632, which ideally is programmed into the internal memory of microprocessor 632.

A further simplification of the ROM 632 look up table is to set the amplitude of the desired signal 202 into rows, and set the phase of the desired signal 204 into columns. The element at an intersection of a selected row and column will contain the values of the absolute first carrier angle 218 δ₁ and the absolute second carrier angle 220 δ₂

As mentioned above, both NCO1 602 and NCO2 604 can alternately be programmed by inputting I and Q values of signal samples. From I and Q sample values, the magnitude (“A”) of the desired signal 202 can be computed from:

A=\sqrt{I²+Q²} (4)

and the angle φ of the desired signal 204 φ can be computed from:

$$φ = {tan}^{- 1} ( \frac{Q}{I} ) \qquad ( 5 )$$

If the desired signal 202 magnitude A and desired signal angle 204 φ are available and you want I and Q values, use:

I=A·cos φ (6)

Q=A·sin φ (7)

in a manner well known in the art. A rectangular coordinates to polar coordinates lookup ROM can speed up conversion.

As a practical matter, it may be difficult to accurately control phase shifts through two signal chains. Furthermore, the amplitudes of first carrier 206, R1, and second carrier 208, R2, come out slightly different. An optional process of calculating a phase error value and a gain error value and making an adjustment can easily solve this problem. This is done by intermittently going into a calibration mode with θ₁ and θ₂ both set to 90 degrees. This will reduce or cancel the desired signal 202. The desired signal 202 is sampled by directional coupler 622, and a RF sample is passed to a null detector 640 through a connection 638. The null detector 640 may be a log amplifier, such as Analog Devices integrated circuit part number AD8310. The null detector 640 connects to microprocessor 630 through connection 642. In a calibration mode, θ₂ is adjusted with a phase offset until the desired signal 202 is minimized. Next, the gain of the second amplifier 618 is slightly increased or decreased via a gain change using a control line 636 until the desired signal 202 is reduced to zero. The gain can be reduced by a slight adjustment in the supply voltage or by an attenuator value change.

The microprocessor 630 can be one of several types that have built-in analog-to-digital converters.

The high power combiner 620 should have good input port-to-port isolation so that a phase shift of the signal on one port will not affect the phase of the signal on the other port. Also the antenna load should be a good impedance match to prevent a reflection back to the high power combiner 620. At microwave frequencies a circulator could be used. Combiners, as commonly used in the communications industry, have an input to output insertion loss of 3 dB. When the first carrier 206 and the second carrier 208 are in-phase (θ₁=θ₂=0) they are added on a voltage basis, which gives a 6 dB addition. Therefore the peak power is greater than the power of either the carrier by 3 dB, and no power is lost. When the two carriers are out of phase (θ₁=θ₂=90) the combiner 620 absorbs the combined power.

If there is an imbalance between the phase and/or the amplitude of the first carrier 206 and the second carrier 208, and a desired signal 202 being generated occasionally passes through the origin (0,0) on the vector plot, the trajectory 216 will never pass through the origin. That is, there will be a hole in the center of the vector diagram due to an imbalance between the two carriers. Another method that can be used to adjust the gain change and phase offset between the two carriers is to shrink the hole in the vector plot. This is done by adjusting the phase offset and the gain change of one of the two carriers while reducing the diameter of the hole in the vector diagram.

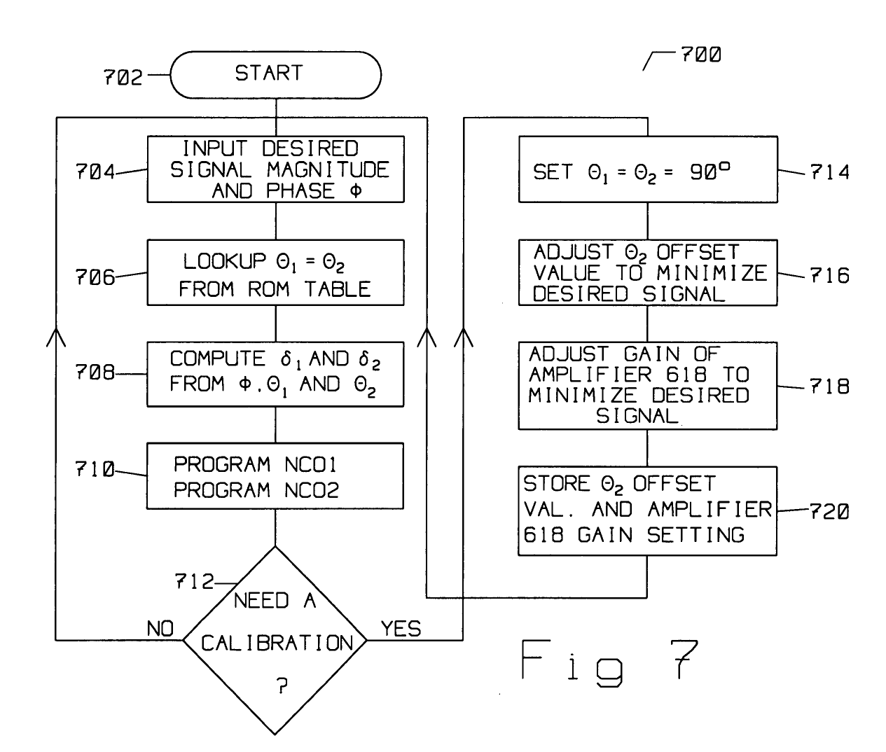

### DESCRIPTION FIG. 7

FIG. 7 is a flow diagram 700 of the process of generating two carriers that will form a desired signal 202 with a vector sum. The flow starts at a step 702. At a step 704 the magnitude and phase of the desired signal are inputted. At a step 706 the value of θ₁ and θ₂ is obtained from a ROM lookup table. In a step 708 the values of δ₁ and δ₂ are computed from φ, θ₁ and θ₂. At a step 710 both NCOs are programmed at the same time. At a step 712 a decision is made to calibrate or not. The decision to calibrate could be based, for example, on a timer, temperature change, or as a result of monitoring the desired signal 202. If no calibration is needed, the flow returns to step 704. If a calibration is needed, the flow goes to a step 714 where θ₁ and θ₂ are set to 90 degrees. At a step 716 the second carrier angle θ₂ is adjusted with the offset angle to minimize the desired signal 202. At a step 718 a gain change of the amplifier 618 is adjusted to further minimize the desired signal 202. At a step 720 the calibration values of the offset angle and the gain change are stored and the calibration is finished. The flow returns to the step 704.

### Summary and Ramifications and Scope

Although the description above contains many specificities, these should not be viewed as limiting the scope of the invention, but as merely providing illustrations of some of the presently preferred embodiment of the invention. For example,
1. The invention may be alternately described as follows: A desired signal is created from a vector sum of two carriers. The two carriers have equal, constant magnitudes but variable angles. Because of vector addition, the relative angle between the two carriers determines the magnitude of the desired signal. The bisection of the two carrier's angles is an angle of the desired signal.
2. The desired signal 202 may be comprised of many signals in different bands summed together into a composite signal For example, the desired signal may be several digital cable television carriers in adjacent bands summed into a single composite wide band signal. Likewise, the composite signal could be several cell phone transmissions that are summed together.
3. The desired signal can be any type of signal. This includes but is not limited to spread spectrum signals, orthogonal frequency division multiplexing, n-QAM, n-VSB, or any of several modulation types used in cellular phones.
4. Because of the ability to efficiently generate high-powered modulated RF carriers, this idea is useful for cellular phones and other portable transmitting devices that have limited battery life.
5. The combiner network can also be free-space, where the first carrier 206 and the second carrier 208 are connected to two separate antennas. The vector combination could be done in a receive antenna.
6. If only one of the two carriers is received, it will be exceedingly difficult to discover what the desired signal 202 should be. Therefore, sending the two carriers signals by two different paths could be used as a form of encryption. For example, one path could be wired and the other path wireless. As another example, one path could be at one frequency and the other path at a different frequency.
7. The calibration of an offset angle and gain change can be accomplished by monitoring from a remote point.
8. It is assumed that any necessary filtering of the desired signal 202 has already been done and is reflected in the magnitude and phase values of desired signal 202.
9. It is desirable to reduce parts count, so single integrated circuit can be used that incorporates several functions, including both digital and analog circuits. Digital functions that could be combined include both NCOs, microprocessor, and ROM.
10. The method of combining two constant value carriers to make a high power signal can be extended to reduce the amplitude of the created high power signal. That is, since any signal with an amplitude of less than twice R1's amplitude can be created, the method can also be used to attenuate the desired signal 202.
11. Interpolation can be used to create more samples points for the NCO's programming. This can be done by taking a current desired signal sample magnitude and phase, a next sample's magnitude and phase and computing a magnitude and phases in between.
12. The desired signal that is generated may be transmitted, recorded, or used locally in a process. Such processes may include use in test equipment or driving transducers.

What I claim is:

1. A method to generate a desired signal comprising:
Generating a first carrier with a first carrier angle and a first carrier magnitude;
Generating a second carrier with a second carrier angle and a second carrier magnitude that is equal to the magnitude of the first carrier;
Adjusting the first carrier angle and the second carrier angle to form the desired signal with a desired signal magnitude and a desired signal angle;
wherein the desired signal is a vector sum of the first carrier and the second carrier.

2. A system according to claim 1 wherein the first carrier and the second carrier are high-powered carriers.

3. A system according to claim 1 wherein a offset angle and a gain change on one of the carriers are adjusted to null the desired signal in a calibration mode.

3. A system according to claim 1 wherein an offset angle and a gain change of the second carrier is adjusted to null the desired signal by shrinking a hole in the vector plot.

4. A system according to claim 1 wherein the first carrier and the second carrier are generated by numerically controlled oscillators.

5. A system according to claim 1 wherein numerically controlled oscillators are controlled by inputting magnitude values and phase values.

6. A system according to claim 6 wherein numerically controlled oscillators are controlled by inputting in-phase values and quadrature values.

7. A system according to claim 1 wherein the desired signal is transmitted.

8. A system for transmitting a desired signal comprised of:
a first carrier with a first fixed amplitude value and an absolute first carrier angle;
a second carrier with a second fixed amplitude value and an absolute second carrier angle;
the first fixed amplitude value is equal to the second fixed amplitude value;
a combiner for combining the first carrier and the second carrier into the desired signal;
a means for transmitting the desired signal;
wherein the transmitted desired signal is a vector sum of the first carrier and the second carrier.

9. A system according to claim 8 wherein the first carrier and the second carrier are applied to two different antennas.

10. A system according to claim 8 wherein the same system is used for a plurality of modulation types.

11. A system for generating a desired signal comprised of:
a first carrier with a first fixed amplitude value and an absolute first carrier angle;
a second carrier with a second fixed amplitude value and an absolute second carrier angle;
the first fixed amplitude value is equal to the second fixed amplitude value;
a combiner for combining the first carrier and the second carrier into a desired signal;
wherein the generated desired signal is a vector sum of the first carrier and the second carrier.

12. A system according to claim 11 wherein the desired signal is used to drive a transducer.

13. A system according to claim 11 wherein the desired signal is used without transmission.

14. A system according to claim 11 wherein energy is conserved.
